(19) United States
(12) Patent Application Publication
(10) Pub. No.: US 2025/0053824 A1
(43) Pub. Date: Feb. 13, 2025

(54) METHOD AND APPARATUS FOR TRAINING A MULTI-TASK FUSION DETECTION MODEL, MULTI-TASK DETECTION METHOD AND APPARATUS

(71) Applicant: BEIJING BAIDU NETCOM SCIENCE TECHNOLOGY CO., LTD., Beijing (CN)

(72) Inventors: Xiaofan Li, Beijing (CN); Ji Wan, Beijing (CN)

(73) Assignee: BEIJING BAIDU NETCOM SCIENCE TECHNOLOGY CO., LTD., Beijing (CN)

(21) Appl. No.: 18/933,204

(22) Filed: Oct. 31, 2024

(30) Foreign Application Priority Data
Jun. 20, 2024 (CN) 202410804835.6

(51) Int. Cl. G06N 3/096

(52) U.S. Cl. CPC G06N 3/096

(57) ABSTRACT

Provided a method for training a multi-task fusion detection model includes: obtaining a single-task detection model of each detection task in a detection task set, and obtaining an initial multi-task fusion detection model to be trained based on each single-task detection model; obtaining a training sampling set of the initial multi-task fusion detection model by obtaining a single-task sampling data set of each detection task, in which the training sample set includes a single-task sample and a multi-task sample; and training the initial multi-task fusion detection model according to the single-task sample and/or the multi-task sample until the training is completed, to obtain a trained target multi-task fusion detection model.

### CROSS-REFERENCE TO RELATED APPLICATION

The present application claims priority to and benefits of Chinese Patent Application Serial No. 202410804835.6, filed on Jun. 20, 2024, the entire content of which is incorporated herein by reference.

### TECHNICAL FIELD

The disclosure relates to a field of data processing, in particular to a field of artificial intelligence technologies such as computer vision and deep learning, and is applicable to a field of automatic driving.

### BACKGROUND

With the development of technologies, a driving assistance function of a vehicle based on visual recognition is more and more important for driving experience of the vehicle. When driving the vehicle, there is a need for performing the visual recognition on different objects appearing on the road.

In the related art, corresponding detection models may be set up for different types of objects to be recognized and deployed on a vehicle end, but a large amount of detection models may have an impact on performances of the vehicle to some extents.

### SUMMARY

According to a first aspect of the disclosure, a method for training a multi-task fusion detection model is provided. The method includes: obtaining a single-task detection model of each detection task in a detection task set, and obtaining an initial multi-task fusion detection model to be trained based on each single-task detection model; obtaining a training sampling set of the initial multi-task fusion detection model by obtaining a single-task sampling data set of each detection task, in which the training sample set includes a single-task sample and a multi-task sample; and training the initial multi-task fusion detection model according to the single-task sample and/or the multi-task sample until the training is completed, to obtain a trained target multi-task fusion detection model.

According to a second aspect of the disclosure, a multi-task detection method is provided. The method includes: obtaining a trained target multi-task fusion detection model, in which the target multi-task fusion detection model is obtained based on the method described in the first aspect; obtaining a target sampling data set to be recognized and inputting the target sampling data set into the target multi-task fusion detection model, and determining, according to the target multi-task fusion detection model, a target detection task to which each target sampling data in the target sampling data set belongs; and obtaining a detection branch, in the target multi-task fusion detection model, of each target sampling data based on the target detection task, to obtain a target task detection result of each target sampling data.

According to a third aspect of the disclosure, an electronic device is provided. The electronic device includes: at least one processor, and a memory communicatively connected to the at least one processor. The memory stores instructions executable by the at least one processor. When the instructions are executed by the at least one processor, the at least one processor is caused to perform the method for training a multi-task fusion detection model of the first aspect and/or the multi-task detection method of the second aspect.

According to a fourth aspect of the disclosure, a non-transitory computer-readable storage medium having computer instructions stored thereon is provided. The computer instructions are configured to cause a computer to perform the method for training a multi-task fusion detection model of the first aspect and/or the multi-task detection method of the second aspect.

It should be understood that the content described in this section is not intended to identify key or important features of the embodiments of the disclosure, nor is it intended to limit the scope of the disclosure. Additional features of the disclosure will be easily understood from the following description.

### BRIEF DESCRIPTION OF THE DRAWINGS

The accompanying drawings are used to better understand this solution and do not constitute a limitation to the disclosure.

FIG. 1 is a flowchart of a method for training a multi-task fusion detection model of an embodiment of the disclosure.

FIG. 2 is a schematic diagram of each single-task detection model of an embodiment of the disclosure.

FIG. 3 is a flowchart of a method for training a multi-task fusion detection model of another embodiment of the disclosure.

FIG. 4 is a schematic diagram of constructing a multi-task fusion detection model of an embodiment of the disclosure.

FIG. 5 is a schematic diagram of obtaining homologous multi-task sampling data of an embodiment of the disclosure.

FIG. 6 is a flowchart of a multi-task detection method of an embodiment of the disclosure.

FIG. 7 is a schematic diagram of a training apparatus of a multi-task detection model of an embodiment of the disclosure.

FIG. 8 is a schematic diagram of a multi-task detection apparatus of an embodiment of the disclosure.

FIG. 9 is a block diagram of an electronic device of an embodiment of the disclosure.

### DETAILED DESCRIPTION

The following description of exemplary embodiments of the disclosure is provided in combination with the accompanying drawings, which includes various details of the embodiments of the disclosure to aid in understanding, and should be considered merely exemplary. Those skilled in the art understood that various changes and modifications of the embodiments described herein may be made without departing from the scope and spirit of the disclosure. For the sake of clarity and brevity, descriptions of well-known functions and structures are omitted from the following description.

Data processing is a basic part of system engineering and automatic control. Data is a form of expression of facts, concepts or instructions that may be processed by manual or automatic apparatuses. Data becomes information when the data is interpreted and given a certain meaning. Data processing refers to collection, storage, retrieval, processing, transformation and transmission of data. The basic purpose of data processing is to extract and derive data that is valuable and meaningful to certain people from a large amount of possibly disorganized and incomprehensible data.

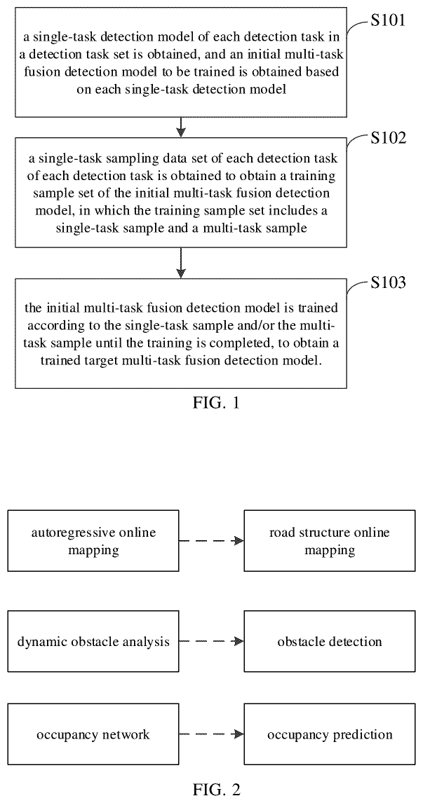

FIG. 1 is a flowchart of a method for training a multi-task fusion detection model of an embodiment of the disclosure. As illustrated in FIG. 1, the method includes the following steps.

At step S101, a single-task detection model of each detection task in a detection task set is obtained, and an initial multi-task fusion detection model to be trained is obtained based on each single-task detection model.

In embodiments of the disclosure, models deployed at a vehicle end may need to perform a variety of types of detection, such as obstacle detection, road structure mapping, and signal light detection, etc. The tasks that need to be detected when the vehicle end realizes its driving assistance function may be determined as the detection tasks of the vehicle end model, so as to obtain the detection task set consisting of a plurality of detection tasks.

As illustrated in FIG. 2, FIG. 2 illustrates a detection task for autoregressive online mapping corresponding to road structure online mapping, a detection task for dynamic obstacle analysis corresponding to obstacle detection, and a detection task for occupancy network corresponding to occupancy prediction. A corresponding detection task set may be obtained based on the plurality of detection tasks illustrated in FIG. 2.

Optionally, each of the detection tasks in the detection task set has its own associated detection model, and the detection model may be labeled as a single-task detection model of each detection task.

In this scenario, the single-task detection model of each detection task may be integrated based on a model integration strategy in the related art, so as to obtain an integrated model that may implement multi-detection tasks, and the model is determined as the initial multi-task fusion detection model to be trained.

At step S102, a single-task sampling data set of each detection task of each detection task is obtained to obtain a training sample set of the initial multi-task fusion detection model, in which the training sample set includes a single-task sample and a multi-task sample.

In embodiments of the disclosure, for any detection task, a sampling data set of the detection task may be obtained based on a data sampling method in the related art, and the sampling data set obtained may be acted as the single-task sampling data set of the detection task, then the single-task sampling data set of each detection task may be obtained.

Optionally, a training sample of the initial multi-task fusion detection model may be obtained based on sampling data corresponding to each single detection task, or may be obtained based on the sampling data of a plurality of detection tasks. In this scenario, the sample obtained based on the sampling data of single detection task may be labeled as the single-task sample, and the sample obtained based on the sampling data of a plurality of detection tasks may be labeled as the multi-task sample.

Furthermore, the set of all the obtained single-task samples and the obtained multi-task samples is labeled as the training sample set of the initial multi-task fusion detection model.

At step S103, the initial multi-task fusion detection model is trained according to the single-task sample and/or the multi-task sample until the training is completed, to obtain a trained target multi-task fusion detection model.

In embodiments of the disclosure, the initial multi-task fusion detection model may be trained based on the single-task sample. A training loss corresponding to the initial multi-task fusion detection model may be obtained under a training round to which the single-task sample belongs, and a model parameter, in the initial multi-task fusion detection model, associated with the single-task sample may be adjusted according to the training loss, to complete the model training in this training round based on the single-task sample.

The initial multi-task fusion detection model may also be trained according to the multi-task sample. A training loss corresponding to the initial multi-task fusion detection model may be obtained under a training round to which the multi-task sample belongs, and a model parameter, in the initial multi-task fusion detection model, associated with the multi-task sample may be adjusted according to the training loss, to complete the model training in this training round based on the multi-task sample.

It is understood that the method for training the initial multi-task fusion detection model proposed in the embodiments of the disclosure may include training alternately based on the single-task sample and the multi-task sample included in the training sample until a training terminating condition is satisfied.

For the model training in the current round, if the model obtained after this round training satisfies a preset model training terminating condition, the training for the initial multi-task fusion detection model may be stopped, and the model obtained at the end of the current round training is determined as the target multi-task fusion detection model that has been trained.

Optionally, the model training terminating condition may be set based on the training round, or may be set based on an output result of the model during training, which will not be specifically defined herein.

According to the method for training the multi-task fusion detection model proposed in the disclosure, the single-task detection model of each detection task is obtained to obtain the initial multi-task fusion detection model to be trained, and the training sample set including the single-task sample and the multi-task sample is obtained according to the single-task sampling data set of each detection task. The initial multi-task fusion detection model is trained according to the single-task sample and the multi-task sample until the training is completed, and the trained target multi-task fusion detection model is obtained. In the disclosure, the initial multi-task fusion detection model to be trained is established based on the single-task detection model of each detection task, which simplifies the method for establishing the multi-task fusion detection model. The initial multi-task fusion detection model is trained based on the multi-task sample and the single-task sample, so that the trained target multi-task fusion detection model can implement a plurality of detection tasks, which, compared with the related art in which single-task detection models are set up for different detection tasks correspondingly, reduces the number of models deployed at the vehicle end, avoids a redundancy of model parameters at the vehicle end caused by the large number of models deployed at the vehicle end, reduces an occupancy rate of the model deployment for resources of the vehicle end, and optimizes a system framework of the vehicle end. Compared with the related art in which a plurality of single-task models needs to be updated and maintained separately, according to the method of the disclosure, a maintenance cost and complexity of the models in the vehicle end is reduced, and the occurrence of unsynchronized updates that may occur when a plurality of single-task models are updated and maintained separately may be avoided. The candidate multi-task fusion detection model is trained through single-task sampling data and multi-task homologous sampling data, which improves a recognition accuracy and efficiency of the trained target multi-task fusion detection model, optimizes the multi-task detection method and detection effect, and reduces an impact of model deployment on performances of the vehicle end system, thereby optimizing a user experience.

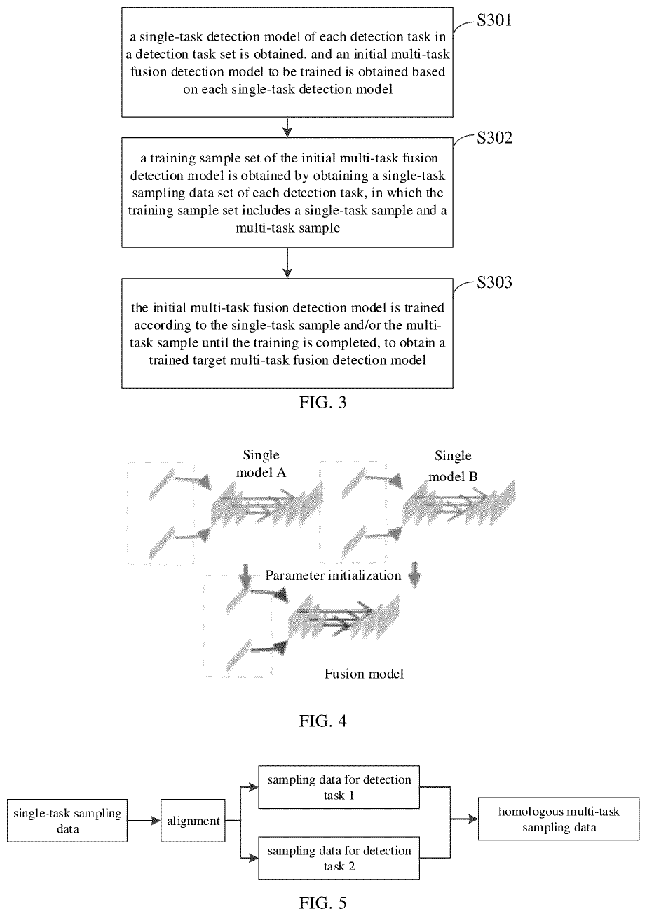

In the above embodiments, the method for obtaining the target multi-task fusion detection model may be understood with reference to FIG. 3. FIG. 3 is a flowchart of a method for training a multi-task fusion detection model of another embodiment of the disclosure. As illustrated in FIG. 3, the method includes the following steps.

At step S301, a single-task detection model of each detection task in a detection task set is obtained, and an initial multi-task fusion detection model to be trained is obtained based on each single-task detection model.

Optionally, for any detection task, model distillation is performed on the single-task detection model of the detection task to obtain a first single-task student model of the single-task detection model. The first single-task student model of each detection task is integrated to obtain the initial multi-task fusion detection model to be trained.

In embodiments of the disclosure, after obtaining the single-task detection model of each detection task, the model distillation may be performed on each single-task detection model, and the model after distillation is determined as the first single-task student model of each single-task detection model.

Distillation may be performed on each single-task detection model by means of parametric distillation or by means of non-parametric distillation, which is not specifically defined herein.

Based on a preset integration method of a multi-task detection model, the first single-task student model after distillation of each single-task detection model is integrated to obtain the integrated initial multi-task fusion detection model.

Optionally, a preset reference model framework is obtained, and a framework adjustment is performed on each first single-task student model according to the reference model framework, to obtain an adjusted second single-task student model.

In embodiments of the disclosure, there may be differences in the model frameworks between each first single-task student model obtained after distillation of the single-task detection model for each detection task, which makes it impossible to integrate all the first single-task student models into the same detection model.

In this scenario, a unified processing needs to be performed on model framework dimension of each first single-task student model. The preset reference model framework corresponding to the initial multi-task fusion detection model may be obtained. The model framework dimension of each first single-task student model may be adjusted respectively according to the reference model framework, and the model of the adjusted framework after the unified processing is determined as the processed second single-task student model.

Optionally, a unified processing is performed on a pre-processing layer of each second single-task student model to obtain a processed third single-task student model.

In embodiments of the disclosure, there may be differences between functions that may be achieved respectively by the pre-processing layer of each second single-task student model, in order to cause the initial multi-task fusion detection model to realize the detection of multi-task data, it is necessary to perform the unified processing on the pre-processing layer of each second single-task student model.

It is understood that network layers included in each second single-task student model are unified, such as an input layer, a feature extraction layer and a normalization layer, are unified processing, so that processed second single-task student models may share a same pre-processing layer. The processed second single-task student models that may share the same pre-processing layer are identified as the processed third single-task student models.

Optionally, a data stream decoupling layer corresponding to each third single-task student model is obtained, and each third single-task student model is integrated according to the data stream decoupling layer to obtain the initial multi-task fusion detection model.

In embodiments of the disclosure, the initial multi-task fusion detection model includes detection branches of the detection task set, and in this scenario, a corresponding multi-task data decoupling layer may be set up between the detection branch and the pre-processing layer. The decoupling layer that decouples the multi-task data may be determined as the corresponding data stream decoupling layer.

It is understood that based on the setting of the data stream decoupling layer, the multi-task data output by the pre-processing layer may be decoupled into a plurality of single-task data, and the plurality of single-task data then is input into the corresponding detection branches, thereby realizing the detection for multi-task data.

A reconstruction and integration of model structure of the data stream decoupling layer and each of the third single-task student models is performed to obtain the initial multi-task fusion detection model.

As an example, after sharing the pre-processing layer by each of third single-task student models, a corresponding data stream decoupling layer may be connected, and model fragments for detection in each of the third single-task student models may be connected after the data stream decoupling layer, thereby realizing the reconstruction and integration of model structure of the data flow decoupling layer and each of the third single-task student models, so as to obtain the initial multi-task fusion detection model.

In embodiments of the disclosure, after combining and reconstructing each of the third single-task student models, it is necessary to perform an initial loading of parameters for the combined and reconstructed models, to obtain the initial multi-task fusion detection model to be trained.

As an example, as shown in FIG. 4, a single model A and a single model B illustrated in FIG. 4 are third single-task student models obtained by distillation, framework unified adjustment, and unified processing on the pre-processing layer through the respective single-task detection models. In the scenario illustrated in FIG. 4, after obtaining the single model A and the single model B, the two models may be integrated and reconstructed to obtain the model after combination and reconstruction. By a parameter initialization method illustrated in FIG. 4, the model parameters of each of the single model A and the single model B are loaded to the model obtained after combination and reconstruction, to obtain a fusion model illustrated in FIG. 4. This fusion model is determined as the initial multi-task fusion detection model obtained based on the integration of the single model A and the single model B.

At step S302, a training sample set of the initial multi-task fusion detection model is obtained by obtaining a single-task sampling data set of each detection task, in which the training sample set includes a single-task sample and a multi-task sample.

Optionally, according to the single-task sampling data set of each detection task, a homologous multi-task sampling data set of each detection task is obtained.

In embodiments of the disclosure, data obtained by sampling for each detection task respectively may be labelled as the single-task sampling data of each detection task. A sampling identification of each single-task sampling data may be obtained, and each single-task sampling data may be clustered according to the sampling identification to obtain a sampling data cluster set. The sampling identification includes a sampling device identification and a sampling time identification.

Optionally, each single-task sampling data has a corresponding sampling identification. The sampling identification may include at least one of the sampling device identification and the sampling time identification. It is understood that according to the sampling identification, information of a time range of the single-task sampling data during collection may be determined. According to the sampling device identification, an area range of corresponding sampling device at the time range may be obtained, and thus information of the area range of the single-task sampling data during collection may be obtained.

In this scenario, the single-task sampling data may be aligned based on the sampling identification. It is understood that the alignment-based operation can filter out data belonging to the same area range and within the same sampling time range from each single-task sampling data of a plurality of detection tasks. The data filtered belonging to the same area range and within the same sampling time range may be determined as the homologous multi-task sampling data of each detection task.

Optionally, each single-task sampling data may be clustered based on the sampling identification, and the single-task sampling data belonging to the same area range and within the same sampling time range may be clustered as the same cluster, and thus the sampling data cluster set is obtained after clustering.

According to the sampling data cluster set, the homogeneous multi-task sampling data set of each detection task is obtained.

It is understood that for any sampling data cluster, all the single-task sampling data included in the cluster have the same sampling area range and the same sampling time range. In such a scenario, it is possible to combine each single-task sampling data in the cluster based on a preset data combination algorithm, so as to obtain the homologous multi-task sampling data corresponding to the sampling data cluster.

According to the homogeneous multi-task sampling data of each sampling data cluster, the corresponding homogeneous multi-task sampling data set is obtained.

As an example, as shown in FIG. 5, the single-task sampling data illustrated in FIG. 5 may be aligned by an alignment module. The sampling data of the detection task 1 and the sampling data of the detection task 2 illustrated in FIG. 5 may be set to the sampling data belonging to the same area region and within the same sampling time range filtered from the single-task sampling data of each detection task through alignment processing. Based on the sampling data of the detection task 1 and the sampling data of the detection task 2 illustrated in FIG. 5, the homogeneous multi-task sampling data illustrated in FIG. 5 is obtained.

Optionally, the multi-task sample of the initial multi-task fusion detection model is obtained according to the homologous multi-task sampling data set, to obtain the training sample set.

In embodiments of the disclosure, algorithmic processing may be performed for each homologous multi-task sampling data in the homologous multi-task sampling data set according to a sample construction algorithm in the related art. The multi-task sample of the initial multi-task fusion detection model is obtained according to results of the algorithmic processing, so as to obtain the training sample set that includes the multi-task sample.

Optionally, the single-task sample of the initial multi-task fusion detection model is obtained according to the single-task sampling data set of each detection task, to obtain the training sample set.

In embodiments of the disclosure, algorithmic processing may be performed for the single-task sampling data set of each detection task according to a sample construction algorithm in the related art. The single-task sample of the initial multi-task fusion detection model is obtained according to results of the algorithmic processing, so as to obtain the training sample set that includes the single-task sample.

At step S303, the initial multi-task fusion detection model is trained according to the single-task sample and/or the multi-task sample until the training is completed, to obtain a trained target multi-task fusion detection model.

In embodiments of the disclosure, the initial multi-task fusion detection model may be alternately trained according to the single-task sample and the multi-task sample, so as to obtain the trained target multi-task fusion detection model that has been trained.

The training of the initial multi-task fusion detection model according to the single-task sample may be understood in combination with the following contents.

Optionally, the initial multi-task fusion detection model is trained according to the single-task sample to obtain a trained first candidate multi-task fusion detection model.

In embodiments of the disclosure, for a current training round of the initial multi-task fusion detection model based on the single-task sample, the model obtained after the training round may be determined as the first candidate multi-task fusion detection model.

A first detection result output by the initial multi-task fusion detection model based on the single-task sample may be obtained, and first label information in the single-task sample may be obtained, in order to obtain a first loss value of the first detection result based on the first label information.

In embodiments of the disclosure, the single-task sample may be input into the initial multi-task fusion detection model, and an output result obtained by the initial multi-task fusion detection model based on the input single-task sample may be labelled as a first detection result.

A label in the single-task sample is labeled as the first label information. Algorithmic processing is performed on the first label information and the first detection result based on a loss value acquisition algorithm in the related art. A loss value of the first detection result based on the first label information is obtained based on the result of the algorithmic processing, and the loss value is noted as the first loss value.

Optionally, a first model parameter, in the initial multi-task fusion detection model, associated with a detection task to which the single-task sample belongs is obtained, and the first model parameter is adjusted and optimized according to the first loss value to obtain the adjusted first candidate multi-task fusion detection model.

In embodiments of the disclosure, there are model parameters shared by each detection task in the initial multi-task fusion detection model, and there are also model parameters associated with each detection task independently. The model parameter associated independently with each detection task may be labeled as the first model parameter, in the initial multi-task fusion detection model, of each detection task.

In this scenario, the first model parameter, in the initial multi-task fusion model, associated with the detection task to which the single-task sample belongs is obtained, and the first model parameter may be adjusted and optimized according to the first loss value, and the adjusted and optimized model may be determined as the first candidate multi-task fusion detection model.

The training of the initial multi-task fusion detection model based on the multi-task sample may be understood in combination with the following contents.

In response to the first candidate multi-task fusion detection model not meeting a preset whole model training terminating condition, the multi-task sample is obtained by returning, and the first candidate multi-task fusion detection model is trained based on the multi-task sample, to obtain a trained second candidate multi-task fusion detection model.

In embodiments of the disclosure, for the first candidate multi-task fusion detection model obtained after the previous round of training, whether it meets the preset whole model training terminating condition may be identified. When it is identified that the first candidate multi-task fusion detection model does not meet the whole model training terminating condition, the next round of model training may be started.

The first candidate multi-task fusion detection model is obtained by training based on the single-task sample. In this scenario, the multi-task sample may be obtained from the training sample set by returning, the next round of model training may be started according to the multi-task sample, and the model obtained after the training based on the multi-task sample is determined as the second candidate multi-task fusion detection model.

In response to the first candidate multi-task fusion detection model not meeting the whole model training terminating condition, a second detection result set output by the first candidate multi-task fusion detection model based on the multi-task sample may be obtained. For any second detection result, second label information, in the multi-task sample, of a detection task to which the second detection result belongs may be obtained to obtain a second loss value of the second detection result based on the second label information.

In embodiments of the disclosure, the multi-task sample may be input into the first candidate multi-task fusion detection model, and an output result set obtained by the first candidate multi-task fusion detection model based on the input multi-task sample may be labelled as the second detection result set.

It is understood that the first candidate multi-task fusion detection model may detect each single task included in the input multi-task sample, and obtain the second detection result for each single task included in the multi-task sample, so as to obtain the second detection result set.

Optionally, for any second detection result, a label corresponding to the second detection result may be obtained from the multi-task sample, and the label may be labeled as the second label information. Algorithmic processing is performed for the second label information and the second detection result according to a loss value acquisition algorithm in the related art, so as to obtain a loss value of the second detection result based on the second label information as the second loss value corresponding to the second detection result.

A second model parameter, in the first candidate multi-task fusion detection model, shared by each detection task are adjusted and optimized according to the second loss value of each second detection result. For any second loss value, a third model parameter, in the first candidate multi-task fusion detection model, associated with a detection task corresponding to the second loss value is adjusted and optimized to obtain the adjusted second candidate multi-task fusion detection model.

In embodiments of the disclosure, the model parameter shared by each detection task in the first candidate multi-task fusion detection model may be labelled as the second model parameter. The model parameter, in the first candidate multi-task fusion detection model, associated with each detection task included in the multi-task sample may be labelled as the third model parameter of each detection task.

In this scenario, the second model parameter may be adjusted and optimized according to the second loss value of each second detection result in the second detection result set. For any second detection result, the third model parameter associated with the second detection result may be adjusted and optimized according to the second detection result, so as to obtain the second candidate multi-task fusion detection model.

Optionally, in response to identifying that that the second candidate multi-task fusion detection model does not meet the model training terminating condition, a next single-task sample and a next multi-task sample are obtained by returning, in order to continue to alternately train the second candidate multi-task fusion detection model by the next single-task sample and the next multi-task sample until the training is completed, and the trained target multi-task fusion detection model is obtained.

In embodiments of the disclosure, after the current round of model training is completed, it may identify whether the model obtained after the current round of training meets the training terminating condition. When it is identified that the second candidate multi-task fusion detection model does not meet the model training terminating condition, it is necessary to return to obtain a next single-task sample and a next multi-task sample from the training sample set and continue alternately training the second candidate multi-task fusion detection model, until the model after a certain round of training meets the whole model training terminating condition, and then the model training may be completed to obtain the trained target multi-task fusion detection model.

Optionally, in response to identifying a third candidate multi-task fusion detection model meets the whole model training terminating condition, the third candidate multi-task fusion detection model is determined to be the trained target multi-task fusion detection model. The third candidate multi-task fusion detection model is one of the first candidate multi-task fusion detection model and the second candidate multi-task fusion detection model.

It is understood that if the current round of model training is implemented based on the single-task sample, the third candidate multi-task fusion detection model is the first candidate multi-task fusion detection model. If the current round of model training is implemented based on the multi-task sample, the third candidate multi-task fusion detection model is the second candidate multi-task fusion detection model.

In this scenario, when it is identified that the third candidate multi-task fusion detection model meets the whole model training terminating condition, the third candidate multi-task fusion detection model may be determined as the trained target multi-task fusion detection model.

The whole model training terminating condition may be set according to the training rounds of the model, or according to an output accuracy of the model, which is not specifically defined herein.

According to the method for training the multi-task fusion detection model proposed in the disclosure, the initial multi-task fusion detection model is trained based on the multi-task sample and the single-task sample, so that the trained target multi-task fusion detection model may implement a plurality of detection tasks, which, compared with the related art in which single-task detection models are set up for different detection tasks correspondingly, reduces the number of models deployed at the vehicle end, avoids a redundancy of model parameters at the vehicle end caused by the large number of models deployed at the vehicle end, reduces an occupancy rate of the model deployment for the resources of the vehicle end, and optimizes a system framework of the vehicle end. The model training of the candidate multi-task fusion detection model may be achieved through single-task sampling data and homologous multi-task sampling data, which improves a recognition accuracy and efficiency of the trained target multi-task fusion detection model.

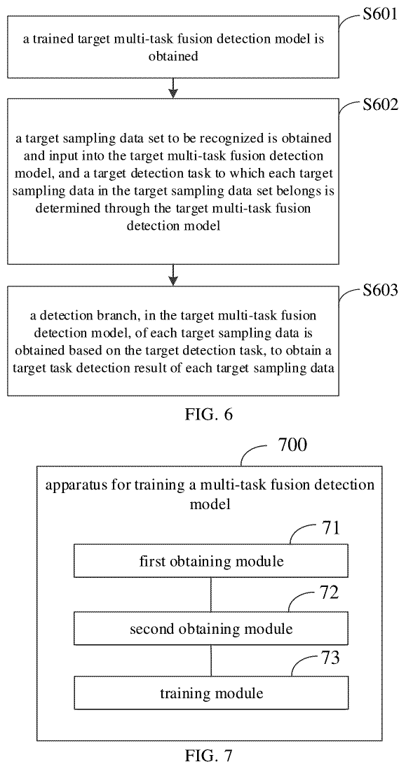

The disclosure also provides a multi-task detection method, which is understood in combination with FIG. 6. FIG. 6 is a flowchart of a multi-task detection method of an embodiment of the disclosure. As illustrated in FIG. 6, the method includes the following steps.

At step S601, a trained target multi-task fusion detection model is obtained.

The target multi-task fusion detection model is obtained based on the method proposed in the embodiments of FIGS. 1-5.

At step S602, a target sampling data set to be recognized is obtained and input into the target multi-task fusion detection model, and a target detection task to which each target sampling data in the target sampling data set belongs is determined through the target multi-task fusion detection model.

In embodiments of the disclosure, data to be identified may be labelled as the target sampling data, and a set consisting of a plurality of target sampling data collected may be labelled as the target sampling data set.

Optionally, the target sampling data set may be input into the trained target multi-task fusion detection model, and the detection task to which each target sampling data belongs may be identified through the target multi-task fusion detection model, so as to obtain the target detection task to which the target sampling data in the target sampling data set belongs.

At step S603, a detection branch, in the target multi-task fusion detection model, of each target sampling data is obtained based on the target detection task, to obtain a target task detection result of each target sampling data.

In embodiments of the disclosure, the target multi-task fusion detection model may include a plurality of detection branches for each detection task, and in this scenario, for any target sampling data, the detection branch, in the target multi-task fusion detection model, corresponding to the target detection task to which the target sampling data belongs may be determined as the detection branch of the target sampling data.

Task detection is performed on the target sampling data according to the detection branch, and a corresponding detection result is output as the target task detection result of the target sampling data.

According to the multi-task detection method proposed in the disclosure, the trained target multi-task fusion detection model is obtained, the task detection is performed on each target sampling data in the target sampling data set to be recognized through the target multi-task fusion detection model, and the target task detection result of each target sampling data is obtained. In the disclosure, the target multi-task fusion detection model, obtained based on the method proposed in the embodiments of FIGS. 1 to 5, implements the task detection for a plurality of target sampling data, without the need to deploy any single-task detection model, which reduces the number of models deployed at the vehicle end, avoids a redundancy of model parameters at the vehicle end caused by the large number of models deployed at the vehicle end, reduces an impact of model deployment on performances of the vehicle end system, and improves a detection accuracy and efficiency of the vehicle end for the target sampling data, thereby optimizing a user experience.

An embodiment of the disclosure also provides an apparatus for training a multi-task fusion detection model. Since the apparatus for training the multi-task fusion detection model proposed in the embodiments of the disclosure corresponds to the method for training the multi-task fusion detection model proposed in the above embodiments, the implementations of the method for training the multi-task fusion detection model described above are also applicable to the apparatus for training the multi-task fusion detection model proposed in the embodiments of the disclosure, which will not be described in detail in the following embodiments.

FIG. 7 is a schematic diagram of an apparatus for training a multi-task fusion detection model of an embodiment of the disclosure. As illustrated in FIG. 7, the apparatus 700 for training a multi-task fusion detection model includes: a first obtaining module 71, a second obtaining module 72, and a training module 73.

The first obtaining module 71 is configured to obtain a single-task detection model of each detection task in a detection task set, and obtain an initial multi-task fusion detection model to be trained based on each single-task detection model.

The second obtaining module 72 is configured to obtain a training sample set of the initial multi-task fusion detection model by obtaining a single-task sampling data set of each detection task, in which the training sample set includes a single-task sample and a multi-task sample.

The training module 73 is configured to train the initial multi-task fusion detection model according to the single-task sample and/or the multi-task sample until the training is completed to obtain a trained target multi-task fusion detection model.

In an embodiment of the disclosure, the first obtaining module 71 is further configured to: obtain a first single-task student model of the single-task detection model by performing model distillation on the single-task detection model of each detection task; and obtain the initial multi-task fusion detection model to be trained by integrating the first single-task student model of each detection task.

In an embodiment of the disclosure, the first obtaining module 71 is further configured to: obtain a preset reference model framework, and obtain each adjusted second single-task student model by performing a framework adjustment on each first single-task student model according to the reference model framework; obtain a processed third single-task student model by performing a unified processing on a pre-processing layer of each second single-task student model; and obtain a data stream decoupling layer corresponding to each third single-task student model, and obtain the initial multi-task fusion detection model by integrating each third single-task student model according to the data flow decoupling layer.

In an embodiment of the disclosure, the second obtaining module 72 is further configured to: obtain a homologous multi-task sampling data set of each detection task according to the single-task sampling data set of each detection task; and obtain the training sample set by obtaining the multi-task sample of the initial multi-task fusion detection model according to the homologous multi-task sampling data set.

In an embodiment of the disclosure, the second obtaining module 72 is further configured to: obtain a sampling identification of each single-task sampling data, and obtain a sampling data cluster set by clustering each single-task sampling data according to the sampling identification, in which the sampling identification includes a sampling device identification and a sampling time identification; and obtain the homologous multi-task sampling data set of each detection task according to the sampling data cluster set.

In an embodiment of the disclosure, the second obtaining module 72 is further configured to: obtain the training sample set by obtaining the single-task sample of the initial multi-task fusion detection model according to the single-task sampling data set of each detection task.

In an embodiment of the disclosure, the training module 73 is further configured to: train the initial multi-task fusion detection model according to the single-task sample to obtain a trained first candidate multi-task fusion detection model; return to obtain the multi-task sample and train the first candidate multi-task fusion detection model, to obtain a trained second candidate multi-task fusion detection model; in response to identifying that the first candidate multitask fusion detection model does not meet a preset whole model training terminating condition, return to obtain a next single-task sample and a next multi-task sample and continue to train the second candidate multi-task fusion detection model by the next single-task sample and the next multi-task sample alternately until the training is completed, to obtain the trained target multi-task fusion detection mode.

In an embodiment of the disclosure, the training module 73 is further configured to: obtain a first detection result output by the initial multi-task fusion detection model based on the single-task sample; obtain first label information in the single-task sample to obtain a first loss value of the first detection result based on the first label information; and obtain a first model parameter, in the initial multi-task fusion detection model, associated with a detection task to which the single-task sample belongs, and adjust and optimize the first model parameter based on the first loss value to obtain adjusted the first candidate multi-task fusion detection model.

In an embodiment of the disclosure, the training module 73 is further configured to: in response to the first candidate multitask fusion detection model not meeting the whole model training terminating condition, obtain a second detection result set output by the first candidate multi-task fusion detection model based on the multi-task sample; for any second detection result, obtain second label information, in the multi-task sample, of a detection task to which the second detection result belongs to obtain a second loss value of the second detection result based on the second label information; and adjust and optimize, according to the second loss value of the second detection result, a second model parameter shared by each detection task in the first candidate multi-task fusion detection model, and for any second loss value, adjust and optimize a third model parameter, in the first candidate multi-task fusion detection model, associated with a detection task corresponding to the second loss value, to obtain the adjusted second candidate multi-task fusion detection model.

In an embodiment of the disclosure, the training module 73 is further configured to: in response to identifying that a third candidate multi-task fusion detection model meets the whole model training terminating condition, determine that the third candidate multi-task fusion detection model is the trained target multi-task fusion detection model that has been trained, in which the third candidate multi-task fusion detection model is one of the first candidate multi-task fusion detection model and the second candidate multi-task fusion detection model.

According to the apparatus for training the multi-task fusion detection model proposed in the disclosure, the single-task detection model of each detection task is obtained to obtain the initial multi-task fusion detection model to be trained, and the training sample set including the single-task sample and the multi-task sample is obtained according to the single-task sampling data set of each detection task. The initial multi-task fusion detection model is trained according to the single-task sample and the multi-task sample until the training is completed, and the trained target multi-task fusion detection model is obtained. In the disclosure, the initial multi-task fusion detection model to be trained is established based on the single-task detection model of each detection task, which simplifies the method for establishing the multi-task fusion detection model. The initial multi-task fusion detection model is trained based on the multi-task sample and the single-task sample, so that the trained target multi-task fusion detection model can implement a plurality of detection tasks which, compared with the related art in which single-task detection models are set up for different detection tasks correspondingly, reduces the number of models deployed at the vehicle end, avoids a redundancy of model parameters at the vehicle end caused by the large number of models deployed at the vehicle end, reduces an occupancy rate of the model deployment for resources of the vehicle end, and optimizes a system framework of the vehicle end. Compared with the related art in which a plurality of single-task models needs to be updated and maintained separately, according to the method of the disclosure, a maintenance cost and complexity of the models in the vehicle end is reduced, and the occurrence of unsynchronized updates that may occur when a plurality of single-task models are updated and maintained separately may be avoided. The candidate multi-task fusion detection model is trained through single-task sampling data and multi-task homologous sampling data, which improves a recognition accuracy and efficiency of the trained target multi-task fusion detection model, optimizes the multi-task detection method and detection effect, and reduces an impact of model deployment on performances of the vehicle end system, thereby optimizing a user experience.

An embodiment of the disclosure also provides a multi-task detection apparatus. Since the multi-task detection apparatus proposed in the embodiments of the disclosure corresponds to the multi-task detection method proposed in the above embodiments, the implementations of the multi-task detection method described above are also applicable to the multi-task detection apparatus proposed in the embodiments of the disclosure, which will not be described in detail in the following embodiments.

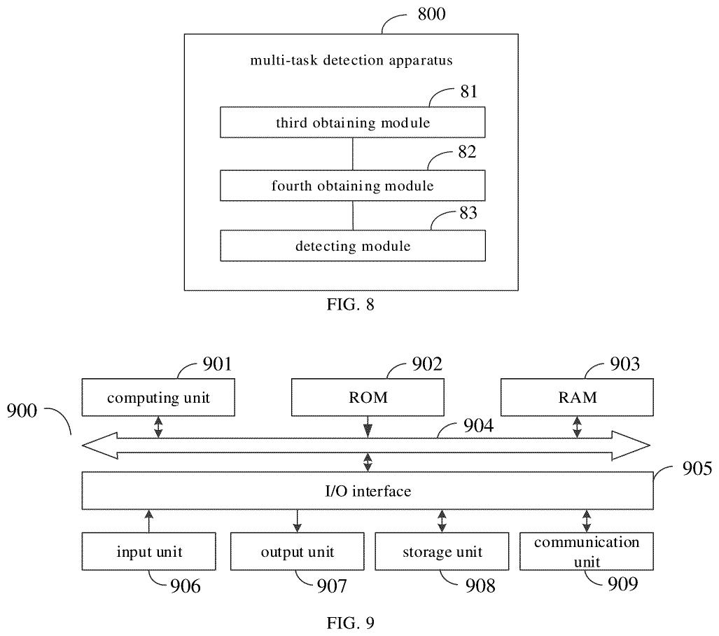

FIG. 8 is a schematic diagram of a multi-task detection apparatus of an embodiment of the disclosure. As illustrated in FIG. 8, the multi-task detection apparatus 800 includes: a third obtaining module 81, a fourth obtaining module 82, and a detecting module 83.

The third obtaining module 81 is configured to obtain a trained target multi-task fusion detection model, in which the target multi-task fusion detection model is obtained based on the method described in the embodiment of FIG. 7.

The fourth obtaining module 82 is configured to obtain a target sampling data set to be recognized and input the target sampling data set into the target multi-task fusion detection model, and determine, according to the target multi-task fusion detection model, a target detection task to which each target sampling data in the target sampling data set belongs.

The detecting module 83 is configured to obtain a detection branch, in the target multi-task fusion detection model, of each target sampling data based on the target detection task, to obtain a target task detection result of each target sampling data.

According to the multi-task detection apparatus proposed in the disclosure, the trained target multi-task fusion detection model is obtained, the task detection is performed on each target sampling data in the target sampling data set to be recognized through the target multi-task fusion detection model, and the target task detection result of each target sampling data is obtained. In the disclosure, the target multi-task fusion detection model, obtained based on the apparatus proposed in the embodiment of FIG. 7, implements the task detection for a plurality of target sampling data, without the need to deploy any single-task detection model, which reduces the number of models deployed at the vehicle end, avoids a redundancy of model parameters at the vehicle end caused by the large number of models deployed at the vehicle end, reduces an impact of model deployment on performances of the vehicle end system, and improves a detection accuracy and efficiency of the vehicle end for the target sampling data, thereby optimizing a user experience.

According to the embodiments of the disclosure, the disclosure also provides an electronic device, a readable storage medium, and a computer program product.

FIG. 9 illustrates a block diagram of an example electronic device 900 that may be used to implement embodiments of the disclosure. The communication device is intended to represent various forms of digital computers, such as laptop computers, desktop computers, workbenches, personal digital assistants, servers, blade servers, mainframe computers, and other suitable computers. The communication device may also represent various forms of mobile devices, such as personal digital processors, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the communication device 900 includes a computing unit 901 for performing various appropriate actions and processes based on computer programs stored in a Read-Only Memory (ROM) 902 or computer programs loaded from the storage unit 908 to a Random Access Memory (RAM) 903. In the RAM 903, various programs and data required for the operation of the device 900 are stored. The computing unit 901, the ROM 902, and the RAM 903 are connected to each other through a bus 904. An input/output (I/O) interface 905 is also connected to the bus 904.

Components in the device 900 are connected to the I/O interface 905, including: an inputting unit 906, such as a keyboard, a mouse; an outputting unit 907, such as various types of displays, speakers; a storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of computing unit 901 include, but are not limited to, a Central Processing Unit (CPU), a Graphics Processing Unit (GPU), various dedicated AI computing chips, various computing units that run ML model algorithms, and a Digital Signal Processor (DSP), and any appropriate processor, controller and microcontroller. The computing unit 901 executes the various methods and processes described above, such as the method for training a multi-task fusion detection model. For example, in some embodiments, the method for training a multi-task fusion detection model may be implemented as a computer software program, which is tangibly contained in a machine-readable medium, such as the storage unit 908. In some embodiments, part or all of the computer program may be loaded and/or installed on the device 900 via the ROM 902 and/or the communication unit 909. When the computer program is loaded on the RAM 903 and executed by the computing unit 901, one or more steps of the method for training a multi-task fusion detection model described above may be executed. Alternatively, in other embodiments, the computing unit 901 may be configured to perform the method for training a multi-task fusion detection model in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, RAMS, ROMs, Electrically Programmable Read-Only-Memories (EPROM), flash memories, fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of distributed system or a server combined with block-chain.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

What is claimed is:

1. A method for training a multi-task fusion detection model, comprising:
obtaining a single-task detection model of each detection task in a detection task set, and obtaining an initial multi-task fusion detection model to be trained based on each single-task detection model;
obtaining a training sample set of the initial multi-task fusion detection model by obtaining a single-task sampling data set of each detection task, wherein the training sample set comprises a single-task sample and a multi-task sample; and
training the initial multi-task fusion detection model according to the single-task sample and/or the multi-task sample until the training is completed, to obtain a trained target multi-task fusion detection model.

2. The method of claim 1, wherein obtaining the single-task detection model of each detection task in the detection task set, and obtaining the initial multi-task fusion detection model to be trained based on each single-task detection model, comprises:
for each detection task, obtaining a first single-task student model of the single-task detection model by performing model distillation on the single-task detection model of the detection task; and
obtaining the initial multi-task fusion detection model to be trained by integrating the first single-task student model of each detection task.

3. The method of claim 2, wherein obtaining the initial multi-task fusion detection model to be trained by integrating the first single-task student model of each detection task, comprises:
obtaining a preset reference model framework, and obtaining an adjusted second single-task student model by performing a framework adjustment on each first single-task student model according to the reference model framework;
obtaining a processed third single-task student model by performing a unified processing on a pre-processing layer of each second single-task student model; and
obtaining a data stream decoupling layer corresponding to each third single-task student model, and obtaining the initial multi-task fusion detection model by integrating each third single-task student model according to the data flow decoupling layer.

4. The method of claim 1, wherein obtaining the training sample set of the initial multi-task fusion detection model by obtaining the single-task sampling data set of each detection task, wherein the training sample set comprises the single-task sample and the multi-task sample, comprises:
obtaining a homologous multi-task sampling data set of each detection task according to the single-task sampling data set of each detection task; and
obtaining the training sample set by obtaining the multi-task sample of the initial multi-task fusion detection model according to the homologous multi-task sampling data set.

5. The method of claim 4, wherein obtaining the homologous multi-task sampling data set of each detection task according to the single-task sampling data set of each detection task, comprises:
obtaining a sampling identification of each single-task sampling data, and obtaining a sampling data cluster set by clustering each single-task sampling data according to the sampling identification, wherein the sampling identification comprises a sampling device identification and a sampling time identification; and
obtaining the homologous multi-task sampling data set of each detection task according to the sampling data cluster set.

6. The method of claim 1, wherein obtaining the training sample set of the initial multi-task fusion detection model by obtaining the single-task sampling data set of each detection task, wherein the training sample set comprises the single-task sample and the multi-task sample, comprises:
obtaining the training sample set by obtaining the single-task sample of the initial multi-task fusion detection model according to the single-task sampling data set of each detection task.

7. The method of claim 1, wherein training the initial multi-task fusion detection model according to the single-task sample and/or the multi-task sample until the training is completed, to obtain the trained target multi-task fusion detection model, comprises:
training the initial multi-task fusion detection model according to the single-task sample to obtain a trained first candidate multi-task fusion detection model;
in response to the first candidate multitask fusion detection model not meeting a preset whole model training terminating condition, returning to obtain the multi-task sample and train the first candidate multi-task fusion detection model, to obtain a trained second candidate multi-task fusion detection model; and
in response to identifying that the second candidate multi-task fusion detection model does not meet the model training terminating condition, returning to obtain a next single-task sample and a next multi-task sample and continue to train the second candidate multi-task fusion detection model by the next single-task sample and the next multi-task sample alternately until the training is completed, to obtain the trained target multi-task fusion detection model.

8. The method of claim 7, wherein training the initial multi-task fusion detection model according to the single-task sample to obtain the trained first candidate multi-task fusion detection model, comprises:
obtaining a first detection result output by the initial multi-task fusion detection model based on the single-task sample;
obtaining first label information in the single-task sample to obtain a first loss value of the first detection result based on the first label information; and
obtaining a first model parameter, in the initial multi-task fusion detection model, associated with a detection task to which the single-task sample belongs, and adjusting and optimizing the first model parameter based on the first loss value to obtain the adjusted first candidate multi-task fusion detection model.

9. The method of claim 7, wherein in response to the first candidate multitask fusion detection model not meeting the preset whole model training terminating condition, returning to obtain the multi-task sample and train the first candidate multi-task fusion detection model, to obtain the trained second candidate multi-task fusion detection model, comprises:
in response to the first candidate multitask fusion detection model not meeting the preset whole model training terminating condition, obtaining a second detection result set output by the first candidate multi-task fusion detection model based on the multi-task sample;
for any second detection result, obtaining second label information, in the multi-task sample, of a detection task to which the second detection result belongs to obtain a second loss value of the second detection result based on the second label information; and
adjusting and optimizing, according to the second loss value of each second detection result, a second model parameter shared by each detection task in the first candidate multi-task fusion detection model, and for any second loss value, adjusting and optimizing a third model parameter, in the first candidate multi-task fusion detection model, associated with a detection task corresponding to the second loss value, to obtain the adjusted second candidate multi-task fusion detection model.

10. The method of claim 7, further comprising:
in response to identifying that a third candidate multi-task fusion detection model meets the whole model training terminating condition, determining that the third candidate multi-task fusion detection model is the trained target multi-task fusion detection model, wherein the third candidate multi-task fusion detection model is one of the first candidate multi-task fusion detection model and the second candidate multi-task fusion detection model.

11. A multi-task detection method, comprising:
obtaining a trained target multi-task fusion detection model;
obtaining a target sampling data set to be recognized and inputting the target sampling data set into the target multi-task fusion detection model, and determining, according to the target multi-task fusion detection model, a target detection task to which each target sampling data in the target sampling data set belongs; and
obtaining a detection branch, in the target multi-task fusion detection model, of each target sampling data based on the target detection task, to obtain a target task detection result of each target sampling data;
wherein the target multi-task fusion detection model is obtained based on a method for training a multi-task fusion detection model, and the method comprises:
obtaining a single-task detection model of each detection task in a detection task set, and obtaining an initial multi-task fusion detection model to be trained based on each single-task detection model;
obtaining a training sample set of the initial multi-task fusion detection model by obtaining a single-task sampling data set of each detection task, wherein the training sample set comprises a single-task sample and a multi-task sample; and
training the initial multi-task fusion detection model according to the single-task sample and/or the multi-task sample until the training is completed, to obtain a trained target multi-task fusion detection model.

12. An electronic device, comprising:
at least one processor; and
a memory communicatively connected to the at least one processor;
wherein the memory stores instructions executable by the at least one processor, when the instructions are executed by the at least one processor, the at least one processor is caused to perform a method for training a multi-task fusion detection model, and the method comprises:
obtaining a single-task detection model of each detection task in a detection task set, and obtaining an initial multi-task fusion detection model to be trained based on each single-task detection model;
obtaining a training sample set of the initial multi-task fusion detection model by obtaining a single-task sampling data set of each detection task, wherein the training sample set comprises a single-task sample and a multi-task sample; and
training the initial multi-task fusion detection model according to the single-task sample and/or the multi-task sample until the training is completed, to obtain a trained target multi-task fusion detection model.

13. A non-transitory computer-readable storage medium having computer instructions stored thereon, wherein the computer instructions are configured to cause a computer to perform the method of claim 1.

14. An electronic device, comprising:
at least one processor; and
a memory communicatively connected to the at least one processor;
wherein the memory stores instructions executable by the at least one processor, when the instructions are executed by the at least one processor, the at least one processor is caused to perform a method of claim 11.

15. A non-transitory computer-readable storage medium having computer instructions stored thereon, wherein the computer instructions are configured to cause a computer to perform the method of claim 11.

16. The multi-task detection method of claim 11, wherein obtaining the single-task detection model of each detection task in the detection task set, and obtaining the initial multi-task fusion detection model to be trained based on each single-task detection model, comprises:
for each detection task, obtaining a first single-task student model of the single-task detection model by performing model distillation on the single-task detection model of the detection task; and
obtaining the initial multi-task fusion detection model to be trained by integrating the first single-task student model of each detection task.

17. The multi-task detection method of claim 16, wherein obtaining the initial multi-task fusion detection model to be trained by integrating the first single-task student model of each detection task, comprises:
obtaining a preset reference model framework, and obtaining an adjusted second single-task student model by performing a framework adjustment on each first single-task student model according to the reference model framework;
obtaining a processed third single-task student model by performing a unified processing on a pre-processing layer of each second single-task student model; and
obtaining a data stream decoupling layer corresponding to each third single-task student model, and obtaining the initial multi-task fusion detection model by integrating each third single-task student model according to the data flow decoupling layer.

18. The multi-task detection method of claim 11, wherein obtaining the training sample set of the initial multi-task fusion detection model by obtaining the single-task sampling data set of each detection task, wherein the training sample set comprises the single-task sample and the multi-task sample, comprises:
obtaining a homologous multi-task sampling data set of each detection task according to the single-task sampling data set of each detection task; and
obtaining the training sample set by obtaining the multi-task sample of the initial multi-task fusion detection model according to the homologous multi-task sampling data set.

19. The multi-task detection method of claim 18, wherein obtaining the homologous multi-task sampling data set of each detection task according to the single-task sampling data set of each detection task, comprises:
obtaining a sampling identification of each single-task sampling data, and obtaining a sampling data cluster set by clustering each single-task sampling data according to the sampling identification, wherein the sampling identification comprises a sampling device identification and a sampling time identification; and
obtaining the homologous multi-task sampling data set of each detection task according to the sampling data cluster set.

20. The multi-task detection method of claim 11, wherein obtaining the training sample set of the initial multi-task fusion detection model by obtaining the single-task sampling data set of each detection task, wherein the training sample set comprises the single-task sample and the multi-task sample, comprises:
obtaining the training sample set by obtaining the single-task sample of the initial multi-task fusion detection model according to the single-task sampling data set of each detection task.
